(19) United States
(12) Patent Application Publication
(10) Pub. No.: US 2007/0022197 A1
(43) Pub. Date: Jan. 25, 2007

(54) Method and system for distributed audio with location based control, management, and delivery

(75) Inventors: Oleg Logvinov, East Brunswick, NJ (US); Brion Ebert, Easton, PA (US)

Correspondence Address: MINTZ LEVIN COHN FERRIS GLOVSKY & POPEO, 666 THIRD AVENUE, NEW YORK, NY, 10017, US

(73) Assignee: Arkados, Inc., North Plainfield, NJ (US)

(21) Appl. No.: 11/454,536

(22) Filed: Jun. 16, 2006

Related U.S. Application Data
(60) Provisional application No. 60/691,217, filed on Jun. 16, 2005.

(51) Int. Cl. G06F 15/173

(52) U.S. Cl. 709/226

(57) ABSTRACT

An audio distribution network for homes, businesses, apartments complexes, and other residential buildings is provided that performs audio distribution over a power line among one or more devices, with either the same audio content being sent to all devices, or different audio content being sent to different devices based on end-user input. This system and method provides for the management and control of these audio streams, as well as the bandwidth management of the power line network, to be performed by one device, or by a number of devices working in unison.

### CROSS REFERENCE TO RELATED APPLICATION

This application claims the benefit of U.S. Provisional Application No. 60/691,217 filed Jun. 16, 2005, which is hereby incorporated by reference herein in its entirety.

### FIELD OF THE INVENTION

Embodiments of the present invention relate to the distribution and management of audio in residences and businesses utilizing infrastructures provided by a local area network, a wide area network, or a combination of the two. This invention can be utilized on a network based on any medium, wired or wireless, but will be described further here in relation to a broadband power line network and/or a local area network based on power line communication. Embodiments of the invention relate generally to the distribution of content, such as audio, video or other data, over conventional electric power conveying media utilized as a local communications network, and more particularly, to utilizing the existing wiring infrastructure for audio distribution.

Embodiments of the invention have uses in at least two areas: (1) a broadband power line access network that provides connectivity to homes, businesses, and other entities, and (2) a high-speed local area power line network in a home, business or other environment that provides connectivity among devices located within the environment. Embodiments of the invention have use in any such network where distributed content storage, origination/sourcing, rendering, and management are desired.

### BACKGROUND OF THE INVENTION

There exist today many types of packet based communication networks, where data is exchanged among a number of devices, based primarily on the actions being performed at any one of the devices. In home entertainment and related networks, the data, or data patterns, can primarily be categorized into three main types: streamed, control and request, and content information. Streamed refers to audio and video data of various formats (MPEG1, MPEG2, MPEG3, AVI, etc.), control and request refers to data that relates to management and control of the audio and video streams, and content information refers to data related to the specifics of audio or video streams available on a network. The bulk, or largest portion, of the data being transmitted is usually the streamed data (it should be also understood that streaming data could be represented by a sequence of packets).

The bulk of current home entertainment and similar networks operate primarily where one or possibly two devices in the network request content at any one time. Therefore, in such networks, it is assumed that the extent of content streaming will involve one or two devices and that primarily one device will initiate substantially all of the actions that occur on the network at any one time. It is also common that such networks are based upon ad-hoc and contention resolution methods of media access and data communication at the lower network protocol layers that do not lend well to the handling of streaming content.

In future content distribution communications networks, it is expected that multiple streams will need to occur simultaneously and can be controlled or requested from various network devices throughout the network, and that the sources of these streams can be one or multiple devices in the network. Consequently, in some circumstances where multiple streams need to be transmitted simultaneously over a content distribution communications network, it is possible that the bandwidth of the network can become taxed. Further, future content distribution communications networks will likely be of a complexity that requires performance of stream management functions related to bandwidth allocation, security, lifetime, digital rights management and other like items.

In current communications networks, the above-type stream management functions would likely be performed at the source of the content being delivered, if the source even includes such functionality at all. In addition, current communications network content management and distribution techniques do not provide for distributing the functionalities, which are expected to be required in future communications networks, throughout the network to minimize complexity of control of content distribution and facilitate satisfactory distribution of content to a plurality of client devices simultaneously requesting content. For example, end-to-end security and complete rights management are not readily accomplished and handled in current networks as both the source and destination devices of any particular content are not aware of and do not themselves include the necessary rights management functionalities. Furthermore, as a single source and/or destination device operating at any one time will no longer represent the norm in future communications networks, the ability to provide for interaction among, and unified control of, the devices in the network in real time, which does not exist in current communications network, will be required.

These and other factors present the need for a network that can utilize distributed content management (e.g., all functions associated with the content handling and digital rights management) and bandwidth control. This invention describes a method and system for accomplishing these and other goals.

### SUMMARY OF THE INVENTION

Embodiments of the invention relate to an audio distribution network for homes, businesses, apartments complexes, and other residential buildings, where streaming audio and multimedia content is sourced/originated, captured, stored, transmitted, received, and rendered through a number of devices located throughout the network. This invention is described for operation on an electrical power distribution network; however, these concepts and methods can be applied to any network, wired or wireless, or a combination of networks, where one of these networks may be a power line network. Embodiments of the invention introduce the idea of a system architecture along with a distributed content management concept, wherein the network bandwidth, the content management functions, and the streaming content itself are controlled by a number of devices acting in unison.

The preferred embodiment described here relates to a local area or wide area broadband power line network. Audio signals are transmitted over the power line by a means of special modulation and demodulation techniques, such as Orthogonal Frequency Division Multiplexing (OFDM) based methods, and delivery protocols that could be based on some of the existing technologies known in the industry, such as the ones proposed by the HomePlug Powerline Alliance (www.homeplug.org). The major benefits of the invention are to overcome the issues associated with, and maximize the performance of, a network where many, multiple, varied, simultaneous audio data streams are taking place and flexible and robust content control are required.

In accordance with an embodiment of the present invention, distribution of content, such as streaming audio and multimedia content, among a plurality of devices located throughout a content distribution communications network is managed to provide for unified control of use of network bandwidth, content management functions and distribution, such as streaming, of the content itself. Unified content management provides for flexible and robust control of content distribution in the network and optimization of network bandwidth, such as in the presence of multiple, varied, simultaneous audio and multimedia data streams. The content, preferably, can be sourced (originated), captured, stored, transmitted, received and rendered at any of the content devices of the network.

In a preferred embodiment, a centralized master content server management device controls multiple content source devices and also the client devices that are distributed over the network and constitute the destinations for the content. The master content server device interacts with the client devices to provide for unified control and management of the distributed content data streams.

In a preferred embodiment, the content distribution communications network is a home entertainment or similar type of network in the form of a local area or wide area broadband power line network.

In an embodiment, a system for distributing audio via a power line is provided that includes a front-end device in communication with a source of audio content and including an audio management engine, and at least one back-end device including an audio rendering engine. The system includes an interface that provides two-way communication over a power line between the front-end device and the back-end device, to allow the front-end device to distribute audio from the source to the back-end device over the power line. In an embodiment, the front-end device transmits the audio to the back-end device in conformance with a channel condition (e.g., bandwidth or frequency) established for communication with the back-end device, as more fully described in the detailed description of the specification.

### BRIEF DESCRIPTION OF THE DRAWINGS

The objects and advantages of the present invention will be apparent from the following detailed description of the presently preferred embodiments, which description should be considered in conjunction with the accompanying drawings in which like reference numerals refer to like parts throughout and in which:

FIG. 1 is a block diagram of a master content management server device and a client device for implementation on a content distribution communications network where distributed audio management can be performed in accordance with an embodiment of the present invention.

FIG. 2 is a diagram of a possible service delivery scenario, which illustrates content delivery on a content distribution communications network using the master device and the client device of FIG. 1.

### DETAILED DESCRIPTION OF THE INVENTION

For purposes of illustration and not limitation, management of distribution of content among a plurality of devices located throughout a content distribution communications network is described in connection with content distribution over a broadband powerline network and a local area network operating based on powerline communication. It is to be understood, however, that the present invention is applicable on a network based on any medium, wired or wireless.

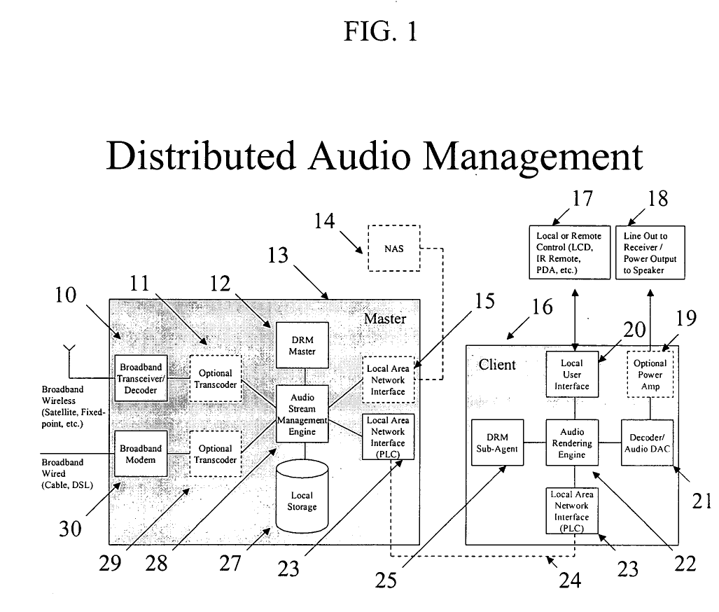

FIG. 1 illustrates a block diagram of a preferred embodiment of a master content server management device 13 connected to a client content management device 16 in accordance with the present invention of managing distribution of content over a content distribution communications network. The present invention operates in connection with an overall communications system architecture, includes system components having an architecture, and uses methods and algorithms relating to system bandwidth determination, system synchronization, content rendering synchronization, content distribution, content protection, content transcoding (such as MPEG 2 to MPEG 4, MPEG 2 to Windows Media 9, etc.), content rendering and overall system optimization, such as described in detail in commonly-owned U.S. application Ser. No. 10/293,129, filed Nov. 13, 2002, U.S. application Ser. No. 10/938,905, filed Sep. 12, 2003, U.S. Provisional Application No. 60/459,828, filed Aug. 31, 2004, U.S. application Ser. No. 11/281,155, filed Nov. 17, 2004, and U.S. Provisional Application No. 60/671,426 for “Method and System for Content Distribution that Can Provide a Measured User Response”, filed Apr. 14, 2005, each of which is hereby incorporated by reference herein in its entirety.

Referring to FIG. 1, the master device 13 includes one or more broadband communication interfaces, including for example a power line interface 23 and optionally a cable or DSL interface 30, and also optionally a broadband wireless interface 10 to a satellite or other feed. In addition, the master device 13 optionally includes a local interface 15 to a network attached storage (“NAS”) device 14. The client device 16 also includes a broadband power line interface 23 and a local interface 20 for interfacing with end point devices, such as a remote control or a PDA 17. The client device optionally may include storage for storing audio content and/or associated audio information (e.g., track title, artist name, genre, etc.). The client device 16 also includes an audio decoder 21 for interfacing with end point output devices 18, such as speakers, stereo inputs, etc. The audio decoder 21 may have line out connectors for inputs to a stereo, and/or may optionally have a power amp 19 for direct connection to speakers. Only one client device has been shown in FIG. 1 to avoid over-complicating the drawing. However, in other embodiments, multiple client devices 16 are connected to a broadband power line communications (“PLC”) network 24 and interface with other client devices and/or the master device 13.

In the master device 13, an audio stream management engine 28 controls the communication and interaction between the other functional blocks within the master device 13. The audio stream management engine 28 preferably has an interface with each of the available content sources in a local area or wide area network. Some of these interfaces may include optional transcoders 11, 29 that process the content data streams so that a universal format data stream is presented to the audio stream management engine 28. Additionally, the audio stream management engine 28 has an interface to a local storage 27 that itself can be a source of streaming content, or alternatively can be used to buffer and store other streams as may be required for synchronization of multiple streams or temporary storage and playback of a stream, respectively. The audio stream management engine 28 controls the sources of the data streams based on the input it receives from the requesting client devices 16 present on the PLC network 24, and also handles the management of bandwidth allocation and control of the PLC network 24. Additionally, audio content and/or associated information that is stored in storage 27 and/or 10 can be accessed directly by client devices. In this scenario, access can be simplified by the user of middleware that stores the content in a predetermined format for convenient retrieval by the client device. Any content type can be accessed by any client device through a unified interface.

In operation, the audio stream management engine 28 receives from the client devices 16, through the PLC interface 23, input data representative of the requested audio and multimedia streams that a client device receives from the associated remote control or PDA device 17, to which the client device is coupled. The audio stream management engine 28 manages transmission of the requested streams, through the PLC interface 23, to the client devices 16. The content is received at the master module 13 from the interface 30 (and/or interface 10) and includes associated data, such as content metadata, external information feed data, special indexes and pre-configured or dynamically created associations, such as filename based associations, that permits the engine 28 to generate, for example, programming guide information and content related data, such as artist and title, for transmission with the content. At the client devices 16, the audio rendering engine 22 manages output of the requested stream, received from the master device 13, to the associated output device 18 for listening, with or without the programming or content related information. The programming or content related information may also be separated from the content steam data by the audio rendering engine 22, and sent out the local interface 20 to the remote or PDA device 17 for viewing, if equipped.

In a preferred embodiment, the audio rendering engine of a client device, in conjunction with the local PLC interface 23, supplies to the master device input data on current and future bandwidth requirements, physical network local link status and parameters related to current capacity and network behavior over time, buffer allocation requirements based on anticipated congestion periods and other related information. The audio stream management engine of the master device can use such information to more effectively and efficiently utilize the network bandwidth in accordance with the present invention.

In a further preferred embodiment, the audio stream management engine 28 at the master device, based on information received from the client devices, as well as from information and historical data stored locally at the storage 27, determines the proper bandwidth allocation and management for all of the streams currently being transmitted. Based upon the historical data stored at the storage 27, as well as current PLC network medium conditions determined at the PLC interface 23 using techniques known in the art, the audio stream management engine 28 allocates sufficient bandwidth, based upon frequency division multiplexing (FDM), frequency band allocation or other techniques well known in the art, for each stream currently being transmitted to allow for proper resolution or accuracy of the original stream. If sufficient bandwidth is not available on the communications network to handle all of the current streaming content, or a bandwidth limiting event takes place such as increased noise on the PLC medium, the master and client devices interact, in accordance with the present invention, to temporarily reduce the resolution or accuracy of one or more of the streams, employ increased buffering or other stream interruptance avoidance methods, or utilize other methods to minimize the effect of these conditions on the playing or playback of any streaming content. For example, the amount of memory available in a client device for storing content can be modified, as suitable, depending on the number of streams simultaneously occurring and the congestion that may be expected to occur on the network.

To further exemplify how the master and client devices interact to determine the proper bandwidth allocation, we can consider a scenario wherein there exists a master device and 3 client devices distributed in three different rooms throughout a house, and connected to each other and the master device through a broadband PLC network. The master device would be streaming 3 different audio streams to 3 different areas of the house, based on requests made from the client devices through user interactions. Each link on the PLC network, both between one client device and the next, and between each client device and the master device, would have a set of characteristics associated with it with regards to, for example, available bandwidth, noise level, best carriers for communication, etc. that would continually be stored and updated at each client device, the master device, or both. As each audio stream is set up and played from the master device to each client device, the bandwidth and transmission parameters are set up based on the particular link information, either present at that time, or based on algorithms that are used to determine the ideal parameters to be used based on historical information regarding the PLC link over time, where a certain “model” of the link or channel is stored and adjusted to determine the expected channel response based on time of day or other factors. In either case, the link information is used along with information regarding other traffic that is taking place on the network to determine how to best set up and transmit the audio stream data to each client device. As mentioned, this setup would determine, among other things, what bandwidth to allocate, what channels or frequency carriers to use, what length of buffers to set up, and what resolution or data rate to use, all based on the current and predicted future characteristics of the PLC link between the master and client device.

Related to this, the ability of “on the fly” adjustments can also be made while the audio stream is in process. Information contained within PLC transmissions between the master and client devices that are taking place while the audio stream is playing can be used to determine if the channel or link characteristics have changed, or it there is additional data traffic from other sources, or other factors that may cause the play of the stream to be disrupted. This information can then be used to make adjustments to the channel link set up parameters to avoid this disruption. For example, new noise on some of the PLC carriers or frequency bands would cause the master and client device to negotiate a new set of link parameters, to use other carriers with less noise, or, there may be sporadic spikes of other data traffic taking place on the PLC network, that may cause a delay of some audio stream packets of data, so the buffers of the client device would be increased, for example, to alleviate this problem.

In an additional scenario, there may be a weak link between a certain client device and the master device, which may make it difficult to transmit a certain audio stream without disruption. There may, however, be a client device that has a sutiable communication link to the one with the weak link, and also has a better link to the master device. In this scenario, the master device would negotiate between the client devices to set up a link using one client device as a “feed-through” to the second client device with the weak link to the master device. The audio stream packets of data would then be sent to the first client device, and the first client device would then forward them to the second client device for playback. The same set up algorithims and parameters described previously would be utilized to set up each link, as well as adjust and maintain the link during the audio stream play.

In a further preferred embodiment, involving distribution of streams having associated rights or lifetimes, the audio stream management engine 28 of the master device 13 exchanges information with the audio rendering engine 22 of a client device to provide for Digital Rights Management (DRM). The audio stream management engine 28 interfaces with a DRM Master 12 to provide DRM information to DRM sub-agents 25, through the audio rendering engines 22 in respective client devices 16, to ensure management and control of the restricted streams based on their parameters, where the content restriction is performed using techniques well known in the art.

The audio decoder 21 within a client device provides that an associated master device can send high bandwidth or a large number of streams to the client device in a compressed, encoded and encrypted format. Advantageously, the decoder at the client device provides that the master device can “feed through” the streams received from the broadband interface, such that only minimal processing needs to be performed at the master device.

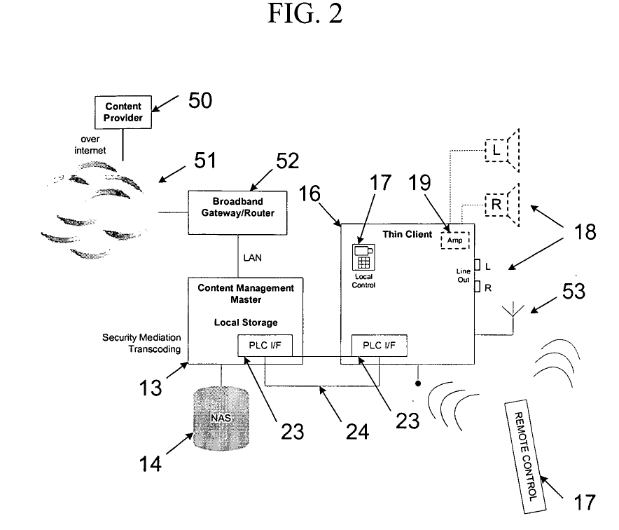

FIG. 2 illustrates an exemplary, secure content delivery implementation where audio or multimedia content is rented and download for playback from a content provider 50. The audio or multimedia content is downloaded based on input from the user, through selections made on the remote control or PDA device 17, based on a menu or other presentations that a content management master server device 13 generates and transmits to the client device 16, which can be a thin client device, and output to the display on the same remote or PDA device, or displayed on an LCD or other display that may be on a local control interface of the client device 16. The audio or multimedia content then is output for playback through connections 18, where it may be input to a stereo, or output through an optional amplifier 19 directly to speakers. The audio or multimedia content is downloaded through the internet 51 and a broadband gateway/router 52, as known in the art, to the master device 13 and then stored on a network attached storage (NAS) device 14 connected to the master device 13. The master device 13 manages distribution of the audio or multimedia content from the content provider 50 based on parameters associated with the content. For example, the audio or multimedia content can include associated, specific rental parameters that the content management master device 13 processes to control, for example, the amount of time the content resides on a storage device within the master device 13 and the amount of time the content is available for play once it is downloaded. In addition, the master device 13 interacts with the client device 16 through the PLC interface 23, over the power line network 24, for streaming the audio or multimedia content to a stereo, speaker, or other playback device, based on input transmitted from the remote device 17 and received at the antenna 53, or other receiver (such as IR), of the client device 16.

Another scenario would be to have all the audio content stored locally at the audio stream management master, or possibly on a locally connected NAS. This audio content could be songs, audio books, other types of Pod-casting, or other content that could be sent to all the client devices available simultaneously. In this scenario, the master and client devices interact to ensure proper timing sequence of content playback through any time synchronization methods known in the art (e.g., time stamps or by use of phase alignment of the power line channel). For example, audio content could be continuously “piped” to all of the rooms or apartments in a residential building, where clients or tenants could enable or disable playing of the content through their local client device. The master device would be centrally located in the building, and would be set up and controlled by the property manager or building owner, who could set up the specific content and schedule of play, which would in turn be communicated to all the clients or tenants, who could then turn on or off play at the client devices based on their preferences.

In a further scenario, more sophisticated master and client devices can be utilized, which would allow the clients or tenants to chose what audio content to play, and when to play it. The audio stream management master would provide a list of available content to the client devices, and the user would select, through a local or remote interface to the client device, what content they would like to hear at any particular time. The property owner or system manager could further set up different levels of service or subscription content, wherein the client or tenant could choose the level of functionality, and the type, or value, of content they would like to hear.

It is to be understood that the exemplary management of distributed content described with reference to FIG. 2 is one of many possible uses of distributed content management and delivery within a multimedia network in accordance with the present invention, and one skilled in the art may realize many other applications and advantages for maximum bandwidth utilization in accordance with the present invention.

Although preferred embodiments of the present invention have been described and illustrated, it will be apparent to those skilled in the art that various modifications may be made without departing from the principles of the invention.

What is claimed is:

1. A system for distributing audio via a power line, said system comprising:
a front-end device in communication with a source of audio content, said front-end device comprising an audio management engine;
at least one back-end device comprising an audio rendering engine; and
an interface providing two-way communication over a power line between said front-end device and said at least one back-end device,
wherein said front-end device is configured to distribute audio from said source to said at least one back-end device over said power line.

2. The system of claim 1, wherein said source of audio content is selected from the group of sources consisting of local storage, a source accessible via the internet, and network attached storage.

3. The system of claim 1, wherein said at least one back-end device comprises an input interface for receiving user input corresponding to an audio selection, wherein said at least one back-end device is configured to transmit data representative of said audio selection to said front-end device over said power line.

4. The system of claim 3, said front-end device is configured to transmit audio corresponding to said audio selection to said at least one back-end device, in response to said front-end device receiving said data indicative of said audio selection from said at least one back-end device.

5. The system of claim 4, wherein said front end device is configured to transmit said audio to said at least one back-end device in conformance with a channel condition that has been determined for communication with said at least one back-end device.

6. The system of claim 1, wherein said system implements intelligent selection of compression and encoding algorithms based on the real-time capacity of said power line.

7. The system of claim 5, wherein said channel condition comprises a bandwidth reservation for said at least one back-end device, said bandwidth reservation selected based upon active and scheduled audio streams and/or data transfers.

8. The system of claim 1 wherein said at least one back-end device is configured to implement a buffer management policy whereby the size of a buffer is selected in order to accommodate for an anticipated congestion occurrence on said power line.

9. The system of claim 1, wherein said system implements a learning algorithm that establishes patterns of link “behavior” and resulting link capacity.

10. The system of claim 1 wherein said front-end device is configured to implement a scheduling policy and local caching in order to support distribution of scheduled audio content to said at least one back-end device over said power line.

11. A system of claim 1, wherein said back-end device utilizes buffering to guarantee latency and support QoS requirements, and said front-end device utilizes caching for optimization of bandwidth usage.

12. The system of claim 1, wherein each of said front-end device and said at least one back-end device comprises a digital rights management component for enforcing usage restrictions on said audio distributed from said front-end device to said back-end device.

13. The system of claim 12, wherein said digital rights management component of said front-end device performs user authentication.

14. The system of claim 12, wherein said digital rights management component of said at least one back-end device performs user authentication.

15. The system of claim 1 wherein said at least one back-end device comprises a thin client with no local storage of audio content.

16. The system of claim 1 wherein said front-end device is configured to transmit audio content information to said at least one back-end device.

17. The system of claim 16, wherein said at least one back-end device is configured to display said audio content information on a display of said at least one back-end device.

18. The system of claim 16, wherein said at least one back-end device is configured to transmit said audio content information to a user input device for display on a display of said user input device.

19. The system of claim 1, wherein said front-end device implements a transcoding function.

20. The system of claim 19, wherein said front-end device implements said transcoding function based on instructions from said at least one back-end device.

21. The system of claim 1 wherein content playback is synchronized among a plurality of nodes through a time synchronization protocol.

22. The system of claim 1 wherein content playback is phase aligned among a plurality of nodes through a specialized synchronization protocol.

23. The system of claim 1 wherein said front-end controls bandwidth management based on data indicating the priory bandwidth demands of other communications on the power line.

24. The system of claim 1 further comprising: middleware that abstracts specific content types from incoming data; and storage for storing data so that any content type can be accessed by any system node through a unified interface.

25. The system of claim 24 wherein audio content and associated information are adopted to the presentment capabilities of the rendering back-end device.

26. The system of claim 1, further comprising storage for storing user profiles that record and track parameters of the content being requested by the user.

27. The system of claim 26 wherein said user profiles are used to suggest future selections for transmission over said power line.

28. The system of claim 26 wherein said user profiles are used to target advertisements for transmission over said power line.

29. The system of claim 28 where the additional suggested selections and the targeted advertising for a user is displayed on the local client LCD screen or the user remote device.

30. A system of claim 28 where the additional suggested selections and the targeted advertising for a user is played out through the client device channels at designated times or in between user selections.

31. A system for distributing audio via a power line, said method comprising:
receiving a request for audio content over a power line; and in response to said receiving:
accessing said audio content from an audio source; and
transmitting said audio content over said power line,
thereby fulfilling said request.
